(19) United States
(12) Patent Application Publication
(10) Pub. No.: US 2026/0245509 A1
(43) Pub. Date: Aug. 20, 2026

(54) DISPLAY DRIVING CIRCUIT, DISPLAY DRIVING METHOD, AND DISPLAY PANEL

(71) Applicant: HKC CORPORATION LIMITED, Shenzhen (CN)

(72) Inventors: YANG PU, Shenzhen (CN); LIDAN YE, Shenzhen (CN)

(21) Appl. No.: 19/489,507

(22) PCT Filed: Apr. 16, 2024
(86) PCT No.: PCT/CN2024/087996

§ 371 Date: Dec. 2, 2025

(30) Foreign Application Priority Data
Jun. 7, 2023 (CN) 202310668130.1

(51) Int. Cl. G09G 3/3225

(52) U.S. Cl. CPC G09G 3/3225; G09G 2300/0465; G09G 2300/0819; G09G 2310/08; G09G 2330/021

(57) ABSTRACT

A display driving circuit includes a first transistor, a storage unit, a first light-emitting control unit, a compensation unit, a data writing unit, and a second light-emitting control unit. The storage unit is connected to a first node and a second node; the first light-emitting control unit is connected to a first light-emitting control line a voltage drain high-voltage end and the first node; the compensation unit is connected to the second node, a third node, a fourth node, a first scan line and a reference voltage line; the data writing unit is connected to the first scan line, a data line and the third node; the second light-emitting control unit is connected to a second light-emitting control line, the fourth node, and an anode of a display light-emitting unit; and a cathode of the display light-emitting unit is connected to a voltage drain low-voltage end.

### CROSS-REFERENCE TO RELATED APPLICATIONS

The present application is a national stage entry under 37 U.S.C. § 371 of International Application No. PCT/CN2024/087996, filed on Apr. 16, 2024, which claims priority to Chinese patent application No. 202310668130.1, filed on Jun. 7, 2023, the entire disclosures of which are hereby incorporated herein by reference

### TECHNICAL FIELD

The present application belongs to the field of display, specifically relates to a display driving circuit, a display driving method, and a display panel.

### BACKGROUND

Organic light-emitting Diode (OLED) display panels have the advantages such as self-illumination, flexibility, thinness, high brightness, low power consumption, fast response, and wide color gamut, and are widely used in electronic products such as TVs, mobile phones, and laptops.

The driving method of OLED is current-driven. The OLED is connected to the driving transistor, and the magnitude of the driving current flowing through the driving transistor directly determines the brightness of the OLED. During the preparation process of driving transistors, it is difficult to achieve absolute uniformity of the film quality at each position. There are differences in the threshold voltage Vth of each driving transistor, which leads to differences in the brightness of OLEDs, that is, uneven display on the display panel. In addition, since the power supply voltage Vdd at the high-voltage end of a power supply also experiences a voltage drop during transmission through the metal lines (especially more obvious in large-sized panels), the drops of the power supply voltage Vdd signals of each OLED are different, which further leads to uneven display on the display panel.

### SUMMARY

There are provided a display driving circuit, a display driving method, and a display panel according to embodiments of the present application. The technical solution is as below.

According to one aspect of the present application, the present application provides a display driving circuit, which includes:
a display driving circuit, including a first transistor connected to a display light-emitting unit;
the display driving circuit further includes:
a storage unit, with a first end connected to a first end of the first transistor through a first node;
a first light-emitting control unit, connected to a first light-emitting control line, a high-voltage end of a power supply, and the first node;
a compensation unit, connected to a second end of the storage unit through a second node, connected to a control end of the first transistor through a third node, and connected to a second end of the first transistor through a fourth node;
the compensation unit is also connected to a first scanning line and a reference voltage line, and is configured to write a voltage of the reference voltage line, a voltage of a high-voltage end of the power supply, and a threshold voltage of the first transistor into the storage unit in response to a signal of the first scanning line;
a data writing unit, connected to the first scanning line, a data line, and the third node;
the data writing unit is configured to write a signal of the data line into the storage unit in response to the signal of the first scanning line;
a second light-emitting control unit, connected to a second light-emitting control line, the fourth node, and an anode of the display light-emitting unit; and
a cathode of the display light-emitting unit is connected to a low-voltage end of the power supply.

According to another aspect of the present application, the present application provides a display driving method, which is configured for driving the display driving circuit, and includes:
in an initialization phase, controlling the first scanning line and the second light-emitting control line to output high-level signals, and controlling the first light-emitting control line to output a low-level signal, to turn on the first light-emitting control unit and the data writing unit, and turn off the second light-emitting control unit, and writing the voltage of the high-voltage end of the power supply into the first node and write a data voltage of the data line into the third node to turn on the first transistor;
in a data writing phase, controlling the first scanning line, the first light-emitting control line, and the second light-emitting control line to output high-level signals, to turn on the data writing unit and turn off the first light-emitting control unit and the second light-emitting control unit, to write the data voltage and the threshold voltage of the first transistor into the first node;
in a first compensation phase, controlling the second light-emitting control line to output a high-level signal, and controlling the first scanning line and the first light-emitting control line to output low-level signals, to turn on the first light-emitting control unit and turn off the data writing unit and the second light-emitting control unit, to write the voltage of the reference voltage line, the data voltage, the threshold voltage, and the voltage of the high-voltage end of the power supply into the second node and the third node;
in a light-emitting phase, controlling the first scanning line, the first light-emitting control line, and the second light-emitting control line to output low-level signals, to turn on the first light-emitting control unit, the first transistor, and the second light-emitting control unit to drive the display light-emitting unit to emit light

According to yet another aspect of the present application, the present application provides a display panel, which includes:
the display driving circuit; and
a display light-emitting unit connected to the second light-emitting control unit of the display driving circuit.

Other features and advantages of the present application will become apparent through the following detailed description, or may be partially learned through the practice of the present application.

It should be understood that the above general description and the following detailed description are merely exemplary and explanatory, and cannot limit the present disclosure.

### BRIEF DESCRIPTION OF THE DRAWINGS

In order to make the content of the present disclosure more easily and clearly understood, the present disclosure will be further described in detail below according to specific embodiments of the present disclosure and in conjunction with the accompanying drawings, in which:

The accompanying drawings here are incorporated into the specification and constitute a part of the specification, showing the embodiments conforming to the present application, and are used together with the specification to explain the principles of the present application. Obviously, the accompanying drawings in the following description are only some embodiments of the present application. For those skilled in the art, other accompanying drawings can be obtained according to these accompanying drawings without creative efforts.

FIG. 1 is a schematic structural diagram of the display driving circuit in the first embodiment of the present application.

FIG. 2 is a control timing diagram of the display driving circuit in the first embodiment of the present application.

FIG. 3 is a flowchart of the display driving method in the second embodiment of the present application.

FIG. 4 is a schematic diagram of the display driving circuit in the initialization stage in the second embodiment.

FIG. 5 is a schematic diagram of the display driving circuit in the data writing stage in the second embodiment.

FIG. 6 is a schematic diagram of the display driving circuit in the first compensation stage in the second embodiment.

FIG. 7 is a schematic diagram of the display driving circuit in the second compensation stage in the second embodiment.

FIG. 8 is a schematic diagram of the display driving circuit in the light-emitting stage in the second embodiment.

FIG. 9 is a schematic structural diagram of the display panel in the third embodiment of the present application.

### DETAILED DESCRIPTION OF THE EMBODIMENTS

Now, the exemplary embodiments will be described more comprehensively with reference to the accompanying drawings. However, the exemplary embodiments can be implemented in various forms and should not be construed as being limited to the examples set forth herein; rather, these embodiments are provided so that the present application will be more thorough and complete, and will fully convey the concept of the exemplary embodiments to those skilled in the art.

Furthermore, the described features, structures, or characteristics may be combined in any suitable manner in one or more embodiments. In the following description, numerous specific details are provided in order to give a thorough understanding of the embodiments of the present application. However, those skilled in the art will recognize that the technical solutions of the present application can be practiced without one or more of the specific details, or other methods, components, devices, steps, etc. may be used. In other cases, well-known methods, devices, implementations, or operations are not shown or described in detail to avoid obscuring various aspects of the present application.

The present application will be further described in detail below in conjunction with the accompanying drawings and specific embodiments. It should be noted here that the technical features involved in the various embodiments of the present application described below can be combined with each other as long as they do not conflict with each other. The embodiments described below with reference to the accompanying drawings are exemplary and are intended to explain the present application, and should not be construed as limiting the present application.

### The First Embodiment

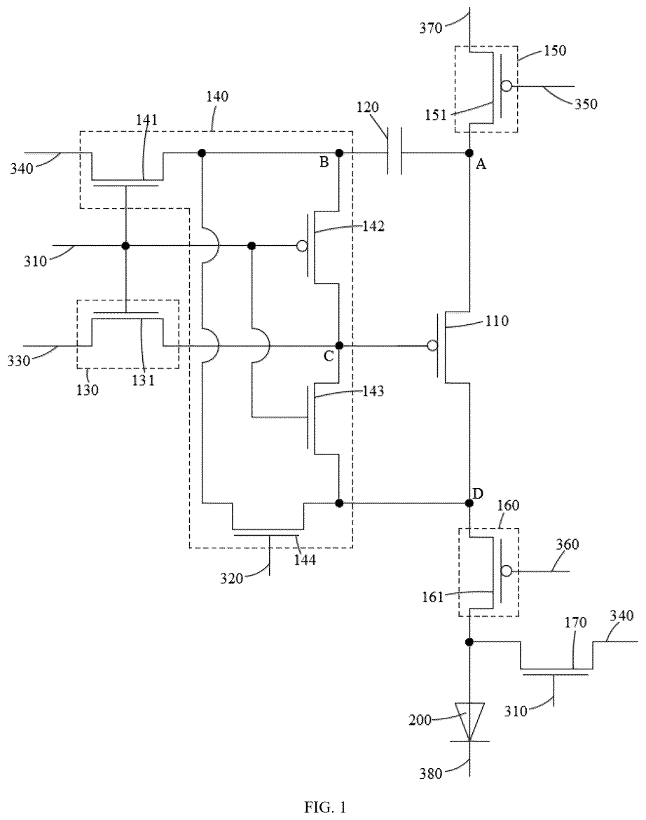

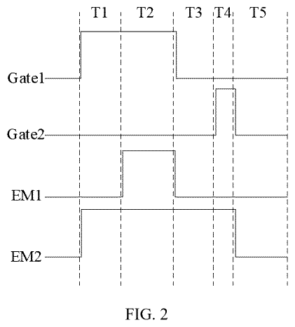

FIG. 1 is a schematic structural diagram of the display driving circuit in the first embodiment of the present application, and FIG. 2 is a control timing diagram of the display driving circuit in the first embodiment of the present application. As shown in FIG. 1 and FIG. 2, the display driving circuit in this embodiment includes a first transistor 110, a storage unit 120, a data writing unit 130, a compensation unit 140, a first light-emitting control unit 150, and a second light-emitting control unit 160. The first transistor 110 includes a control end, a first end, and a second end. The first transistor 110 serves as a driving transistor, and the second end of the first transistor 110 is indirectly connected to the anode of the display light-emitting unit 200. The control end, the first end, and the second end of the first transistor 110 can be its gate, source, and drain respectively. The display light-emitting unit 200 may include an organic light-emitting diode.

The first end of the storage unit 120 is connected to the first end of the first transistor 110 through the first node A, and the second end of the storage unit 120 is connected to the second node B. The storage unit 120 includes a capacitor, and the capacitor can be used to store charges. The first light-emitting control unit 150 is connected to the first light-emitting control line 350, the high-voltage end 370 of the power supply, and the first node A. The first light-emitting control line 350 outputs a first light-emitting control signal EM1, and the power supply voltage of the high-voltage end 370 of the power supply is Vdd.

The compensation unit 140 is connected to the second end of the storage unit 120 through the second node B, connected to the control end of the first transistor 110 through the third node C, and connected to the second end of the first transistor 110 through the fourth node D. The compensation unit 140 is also connected to the first scanning line 310 and the reference voltage line. The compensation unit 140 is configured to write the voltage Vr of the reference voltage line, the power supply voltage Vdd, and the threshold voltage Vth of the first transistor 110 into the storage unit 120 in response to the signal of the first scanning line 310 (i.e., the scanning signal Gate1).

The data writing unit 130 is connected to the first scanning line 310, the data line 330, and the third node C, and is configured to write the signal of the data line 330 (i.e., the data signal) into the storage unit 120 in response to the signal of the first scanning line 310, and the voltage of the data signal is Vdata. The second light-emitting control unit 160 is connected to the second light-emitting control line 360, the fourth node D, and the anode of the display light-emitting unit 200, and the cathode of the display light-emitting unit 200 is connected to the low-voltage end 380 of the power supply. The second light-emitting control line 360 outputs a second light-emitting control signal EM2, and the voltage Vss of the low-voltage end 380 of the power supply is less than or equal to 0.

When the display light-emitting unit 200 emits light, the current flowing through the first transistor 110, that is, the driving current I_{OLED} is:

$${I}_{OLED} = 1 / 2 \times μ \times k \times {( Vgs - Vth )}^{2}$$

where μ is a carrier mobility, k=W/L, W is the channel width of the first transistor 110, L is the channel length of the first transistor 110, and Vgs is the gate-source voltage difference.

The gate-source voltage difference Vgs is:

$$Vgs = {V}_{C} - {V}_{A}$$

V_{C} is the potential of the third node C, and V_{A} is the potential of the first node A. When the display light-emitting unit 200 emits light, the potential V_{A} of the first node A is equal to the power supply voltage Vdd. The potential V_{A} of the first node A is maintained by the storage unit 120, and the potential V_{A} of the first node A is equal to the potential V_{B} of the second node B. Therefore, Vgs-Vth can eliminate the threshold voltage Vth and the power supply voltage Vdd, that is, the current I_{OLED} flowing through the first transistor 110 is not affected by the power supply voltage Vdd and the threshold voltage Vth.

In this embodiment, the two ends of the storage unit 120 are respectively connected to the first node A and the second node B. The first light-emitting control unit 150 is connected to the first light-emitting control line 350, the high-voltage end 370 of the power supply, and the first node A. The data writing unit 130 is connected to the first scanning line 310, the data line 330, and the third node C. The second light-emitting control unit 160 is connected to the second light-emitting control line 360, the fourth node D, and the anode of the display light-emitting unit 200. The cathode of the display light-emitting unit 200 is connected to the low-voltage end 380 of the power supply. The control end of the first transistor 110 is connected to the third node C, and the first and second ends of the first transistor 110 are respectively connected to the second node B and the fourth node D. The compensation unit 140 is connected to the second node B, the third node C, the fourth node D, the first scanning line 310, and the reference voltage line. The compensation unit 140 is configured to write the voltage of the reference voltage line, the power supply voltage Vdd, and the threshold voltage Vth of the first transistor 110 into the storage unit 120 in response to the scanning signal. By compensating for the threshold voltage Vth and the power supply voltage Vdd, the influence of the threshold voltage Vth and the power supply voltage Vdd on the driving current is eliminated, and the problem of uneven display on the display panel is improved.

For example, as shown in FIG. 1, the compensation unit 140 includes a second transistor 141, a third transistor 142, and a fourth transistor 143. The first transistor 110 and the third transistor 142 are P-type transistors, and the second transistor 141 and the fourth transistor 143 are N-type transistors.

The second transistor 141 includes a control end, a first end, and a second end. The control end of the second transistor 141 is connected to the first scanning line 310, the first end of the second transistor 141 is connected to the reference voltage line, and the second end of the second transistor 141 is connected to the second node B. The control end, the first end, and the second end of the second transistor 141 can be its gate, source, and drain respectively.

The third transistor 142 includes a control end, a first end, and a second end. The control end of the third transistor 142 is connected to the first scanning line 310, the first end of the third transistor 142 is connected to the second node B, and the second end of the third transistor 142 is connected to the third node C. The control end, the first end, and the second end of the third transistor 142 can be its gate, source, and drain respectively.

The fourth transistor 143 includes a control end, a first end, and a second end. The control end of the fourth transistor 143 is connected to the first scanning line 310, the first end of the fourth transistor 143 is connected to the third node C, and the second end of the fourth transistor 143 is connected to the fourth node D. The control end, the first end, and the second end of the fourth transistor 143 can be its gate, source, and drain respectively.

When the display driving circuit is operating, the first light-emitting control unit 150 is turned on, the potential V_{A} of the first node A is the power supply voltage Vdd, the second transistor 141 is turned on, the potential V_{B} of the second node B is Vr, the data writing unit 130 and the fourth transistor 143 are turned on, and the potentials of the third node C and the fourth node D are both Vdata. At this time, the gate-source voltage difference Vgs of the first transistor 110 is that Vgs=V_{C}−V_{A}=Vdata−Vdd. Since the maximum value of the data voltage Vdata is less than the power supply voltage Vdd, then Vgs<Vth, and the first transistor 110 is turned on. After the first transistor 110 is turned on, the first light-emitting control unit 150 is turned off, and the data voltage Vdata will charge the first node A through the fourth transistor 143 and the first transistor 110 until the first transistor 110 is turned off when Vgs=Vth, and the potential V_{A} of the first node A becomes Vdata-Vth, that is, the data voltage Vdata and the threshold voltage Vth are written into the storage unit 120. Then, the first light-emitting control unit 150 and the second light-emitting control unit 160 are turned on, the power supply voltage Vdd charges the first node A, the potential V_{A} of the first node A becomes the power supply voltage Vdd. Due to the conservation of charge, the change in the potential of the second node B is equal to the change in the potential of the first node A, so the potential V_{B} of the second node B becomes Vr+Vdd−Vdata+Vth. Since the third transistor 142 is turned on, the potential V_{C} of the third node C is equal to the potential V_{B} of the second node B, so that the first transistor 110 is turned on again, the current flowing through the first transistor 110, that is, the driving current I_{OLED} is:

$${I}_{OLED} = 1 / 2 \times μ \times k \times {( Vgs - Vth )}^{2}$$

Substituting Vgs=V_{C}−V_{A}, the driving current I_{OLED} is: I_{OLED}=½×μ×k×(Vr+Vdata)²

Since the voltage Vr of the reference voltage line is a constant, the influence of the threshold voltage Vth and the power supply voltage Vdd on the driving current is eliminated, and the problem of uneven display on the display panel is improved.

It should be noted that in this embodiment, the first transistor 110 and the third transistor 142 are P-type transistors, and the second transistor 141 and the fourth transistor 143 are N-type transistors in order to share control signals (including the scanning signal Gate1, the first light-emitting control signal EM1, and the first light-emitting control signal EM2) and reduce the wiring of the display panel. One or more of the first transistor 110, the second transistor 141, the third transistor 142, and the fourth transistor 143 can be P-type transistors or N-type transistors, depending on the specific situation.

In some embodiments, the voltage Vr of the reference voltage line is 0. That is to say, when the power supply voltage Vdd charges the first node A and the potential V_{A} of the first node A becomes the power supply voltage Vdd, the potential V_{B} of the second node B and the potential V_{C} of the third node C are both Vdd-Vdata+Vth, then the driving current I_{OLED} flowing through the first transistor 110 is:

$${I}_{OLED} = 1 / 2 \times μ \times k \times {Vdata}^{2}$$

The driving current I_{OLED} is not affected by the threshold voltage Vth and the power supply voltage Vdd, which improves the problem of uneven display of the display panel.

As shown in FIG. 1, the compensation unit 140 further includes a fifth transistor 144, and the fifth transistor 144 has a control end, a first end, and a second end. The control end of the fifth transistor 144 is connected to the second scanning line 320 (outputting the scanning signal Gate2), the first end of the fifth transistor 144 is connected to the second node B, and the second end of the fifth transistor 144 is connected to the fourth node D. The fifth transistor 144 is an N-type transistor, and the control end, the first end, and the second end of the fifth transistor 144 can be its gate, source, and drain respectively.

When the display driving circuit is operating: after the potential V_{B} of the second node B and the potential V_{C} of the third node C become Vdd-Vdata+Vth, the fifth transistor 144 is turned on, and the current flowing through the first transistor 110 will charge the second node B and the third node C through the fifth transistor 144. If the turn-on time of the fifth transistor 144 is controlled to be t, then the potential change of both the second node B and the third node C is ΔVg=I×t/C (C is the capacitance of the storage unit 120), that is:

$${V}_{B} = {V}_{C} = Vdd - Vdata + Vth + Δ Vg$$

Then the driving current I_{OLED} flowing through the first transistor 110 becomes: I_{OLED}=½×μ×k×(Vdata−ΔVg)²
where μ is the carrier mobility.

From the calculation formula of the driving current I_{OLED}, when the carrier mobility μ increases, ΔVg increases, and (Vdata−ΔVg) decreases. When the carrier mobility 1 decreases, ΔVg decreases, and (Vdata−ΔVg) increases. That is, by compensating for the carrier mobility 11, the influence of the change in the carrier mobility 1 on the driving current I_{OLED} is reduced, thereby improving the problem of uneven display of the display panel.

It should be noted that the fifth transistor 144 can be an N-type transistor, but it is not limited to this. The fifth transistor 144 can also be a P-type transistor, depending on the specific situation. When the fifth transistor 144 is a P-type transistor, the scanning signal Gate2 output by the second scanning line 320 can be adjusted accordingly.

As shown in FIG. 1, the display driving circuit further includes a sixth transistor 170, and the sixth transistor 170 has a control end, a first end, and a second end. The control end of the sixth transistor 170 is connected to the first scanning line 310, the first end of the sixth transistor 170 is connected to the initialization signal line 340, and the second end of the sixth transistor 170 is connected to the anode of the display light-emitting unit. The sixth transistor 170 can be an N-type transistor, and the control end, the first end, and the second end of the sixth transistor 170 can be its gate, source, and drain respectively.

The voltage of the initialization signal line 340 can be set according to the situation. For example, the voltage Vini of the initialization signal line 340 is greater than the power supply voltage Vss of the low-voltage end 380 of the power supply, and the voltage difference between the voltage Vini of the initialization signal line 340 and the power supply voltage Vss is less than the starting voltage of the display light-emitting unit 200 emitting light.

The display driving circuit further includes a sixth transistor 170. The sixth transistor 170 connects the initialization signal line 340 and the anode of the display light-emitting unit 200 in response to the scanning signal. The voltage Vini of the initialization signal line 340 is greater than the power supply voltage Vss and the voltage difference between the voltage Vini of the initialization signal line 340 and the power supply voltage Vss is less than the starting voltage of the display light-emitting unit 200 for emitting light, so that there is a current flowing through the display light-emitting unit 200 but the display light-emitting unit 200 does not emit light, that is, the initialization of the display light-emitting unit 200 is completed. Before each display light-emitting unit 200 emits light, initializing the display light-emitting unit 200 makes the state of each display light-emitting unit 200 before it emits light consistent, which can improve the problem of uneven display of the display panel.

It should be noted that the voltage Vini of the initialization signal line 340 is greater than the power supply voltage Vss, but it is not limited to this. The voltage Vini of the initialization signal line 340 can also be equal to the power supply voltage Vss, and it is only necessary to clear the charge at the anode of the display light-emitting unit 200, depending on the specific situation. During the operation of the display driving circuit, the voltage Vini of the initialization signal line 340 can also be made greater than the power supply voltage Vss at regular intervals, so that the display light-emitting unit 200 is reverse-biased, thereby eliminating the built-in electric field formed by the long-term forward biasing of the display light-emitting unit 200 and improving the light-emitting efficiency and service life of the display light-emitting unit 200.

In addition, the sixth transistor 170 can be an N-type transistor to be controlled by borrowing the scanning signal Gate1, but it is not limited to this. The sixth transistor 170 can also be a P-type transistor, depending on the specific situation.

As shown in FIG. 1, the voltage of the initialization signal line 340 is 0, and the reference voltage line is the initialization signal line 340. When the voltage of the initialization signal line 340 is 0, the power supply voltage Vss can be less than 0.

Since the voltage of the reference voltage line is 0 and the voltage of the initialization signal line 340 is also set to 0, the initialization signal line 340 and the reference voltage line are the same wire, such a design can reduce the wiring of the display panel and increase the pixel aperture ratio.

As shown in FIG. 1, the data writing unit 130 includes a seventh transistor 131, and the seventh transistor 131 has a control end, a first end, and a second end. The control end of the seventh transistor 131 is connected to the first scanning line 310, the first end of the seventh transistor 131 is connected to the data line 330, and the second end of the seventh transistor 131 is connected to the third node C. The seventh transistor 131 can be an N-type transistor, and the control end, the first end, and the second end of the seventh transistor 131 can be its gate, source, and drain respectively.

The data writing unit 130 includes a seventh transistor 131. The seventh transistor 131 writes the data voltage Vdata into the third node C in response to the scanning signal Gate1, and its structure is simple.

It should be noted that the seventh transistor 131 can be an N-type transistor to be controlled by borrowing the scanning signal Gate1, but it is not limited to this. The seventh transistor 131 can also be a P-type transistor, depending on the specific situation.

As shown in FIG. 1, the first light-emitting control unit 150 includes an eighth transistor 151, and the eighth transistor 151 has a control end, a first end, and a second end. The control end of the eighth transistor 151 is connected to the first light-emitting control line 350, the first end of the eighth transistor 151 is connected to the high-voltage end 370 of the power supply, and the second end of the eighth transistor 151 is connected to the first node A. The eighth transistor 151 is a P-type transistor, and the control end, the first end, and the second end of the eighth transistor 151 can be its gate, source, and drain respectively.

The first light-emitting control unit 150 includes an eighth transistor 151. The eighth transistor 151 writes the power supply voltage Vdd into the first node A in response to the first light-emitting control signal EM1, and its structure is simple.

It should be noted that the eighth transistor 151 can be a P-type transistor, but it is not limited to this. The eighth transistor 151 can also be an N-type transistor, depending on the specific situation. When the eighth transistor 151 is an N-type transistor, the first light-emitting control signal EM1 can be adjusted accordingly.

As shown in FIG. 1, the second light-emitting control unit 160 includes a ninth transistor 161. The control end of the ninth transistor 161 is connected to the second light-emitting control line 360, the first end of the ninth transistor 161 is connected to the fourth node D, and the second end of the ninth transistor 161 is connected to the anode of the display light-emitting unit 200. The ninth transistor 161 is a P-type transistor, and the control end, the first end, and the second end of the ninth transistor 161 can be its gate, source, and drain respectively.

The second light-emitting control unit 160 includes a ninth transistor 161. The ninth transistor 161 connects the fourth node D and the anode of the display light-emitting unit 200 in response to the second light-emitting control signal EM2, and its structure is simple. It should be noted that the ninth transistor 161 can be a P-type transistor, but it is not limited to this. The ninth transistor 161 can also be an N-type transistor, depending on the specific situation. When the ninth transistor 161 is an N-type transistor, the second light-emitting control signal EM2 can be adjusted accordingly.

### The Second Embodiment

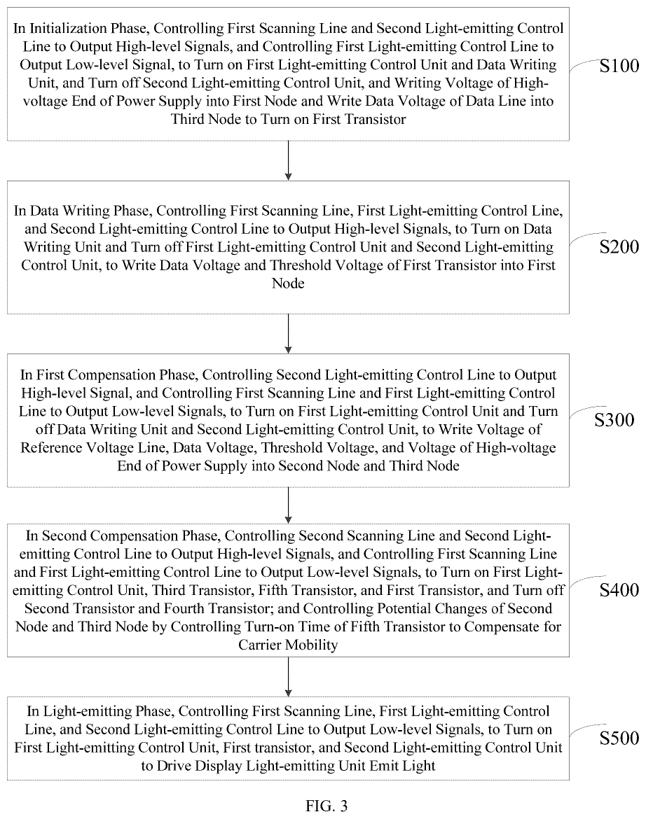

The display driving method in this embodiment is used to drive the display driving circuit in the first embodiment. FIG. 3 is a flowchart of the display driving method in the second embodiment of the present application. As shown in FIGS. 1 to 3, the display driving method includes:
S100: in the initialization stage T1, controlling the first scanning line 310 and the second light-emitting control line 360 to output high-level signals, and controlling the first light-emitting control line 350 to output a low-level signal, to turn on the first light-emitting control unit 150 and the data writing unit 130, and turn off the second light-emitting control unit 160, and writing the power supply voltage Vdd of the high-voltage end 370 of the power supply into the first node A, and writing the data voltage Vdata of the data line 330 into the third node C to turn on the first transistor 110;
S200: in the data writing stage T2, controlling the first scanning line 310, the first light-emitting control line 350, and the second light-emitting control line 360 to output high-level signals, to turn on the data writing unit 130, and turn off the first light-emitting control unit 150 and the second light-emitting control unit 160 to write the data voltage Vdata and the threshold voltage Vth of the first transistor 110 into the first node A;
S300: in the first compensation stage T3, controlling the second light-emitting control line 360 to output a high-level signal, and controlling the first scanning line 310 and the first light-emitting control line 350 to output low-level signals, to turn on the first light-emitting control unit 150, and turn off the data writing unit 130 and the second light-emitting control unit 160 to write the voltage Vr of the reference voltage line, the data voltage Vdata, the threshold voltage Vth, and the power supply voltage Vdd of the high-voltage end 370 of the power supply into the second node B and the third node C;
S500: in the light-emitting stage T5, controlling the first scanning line 310, the first light-emitting control line 350, and the second light-emitting control line 360 to output low-level signals, to turn on the first light-emitting control unit 150, the first transistor 110, and the second light-emitting control unit 160 to drive the display light-emitting unit 200 to emit light.

When the display light-emitting unit 200 emits light, the driving current I_{OLED} is:

$${I}_{OLED} = 1 / 2 \times μ \times k \times {( Vr - Vdata )}^{2}$$

The voltage Vr of the reference voltage line can be 0, and the driving current I_{OLED} is ½×μ×k×Vdata². Therefore, the influence of the threshold voltage Vth and the power supply voltage Vdd on the driving current is eliminated, and the problem of uneven display of the display panel is improved.

In addition, the compensation unit 140 may include a second transistor 141, a third transistor 142, a fourth transistor 143, and a fifth transistor 144. The first transistor 110 and the third transistor 142 are P-type transistors, and the second transistor 141, the fourth transistor 143, and the fifth transistor 144 are N-type transistors.

The control end of the second transistor 141 is connected to the first scanning line 310, the first end of the second transistor 141 is connected to the reference voltage line, and the second end of the second transistor 141 is connected to the second node B. The control end of the third transistor 142 is connected to the first scanning line 310, the first end of the third transistor 142 is connected to the second node B, and the second end of the third transistor 142 is connected to the third node C. The control end of the fourth transistor 143 is connected to the first scanning line 310, the first end of the fourth transistor 143 is connected to the third node C, and the second end of the fourth transistor 143 is connected to the fourth node D. The control end of the fifth transistor 144 is connected to the second scanning line 320, the first end of the fifth transistor 144 is connected to the second node B, and the second end of the fifth transistor 144 is connected to the fourth node D.

The display driving method further includes:
S400: in the second compensation stage T4, controlling the second scanning line 320 and the second light-emitting control line 360 to output high-level signals, and controlling the first scanning line 310 and the first light-emitting control line 350 to output low-level signals, to turn on the first light-emitting control unit 150, the third transistor 142, and the fifth transistor 144, and turn off the second transistor 141 and the fourth transistor 143, and controlling the potential change of the second node B and the third node C by controlling the turn-on time of the fifth transistor 144 to compensate for the carrier mobility 11.

In the second compensation stage T4, after the potential V_{B} of the second node B and the potential V_{C} of the third node C become Vdd-Vdata+Vth, the fifth transistor 144 is turned on, and the current flowing through the first transistor 110 will charge the second node B and the third node C through the fifth transistor 144. If the turn-on time of the fifth transistor 144 is controlled to be t, then the potential changes of the second node B and the third node C each is ΔVg=I×t/C, that is:

$${V}_{B} = {V}_{C} = Vdd - Vdata + Vth + Δ Vg$$

Then the driving current I_{OLED} flowing through the first transistor 110 becomes:

$${I}_{OLED} = 1 / 2 \times μ \times k \times {( Vdata - Δ Vg )}^{2}$$

where μ is the carrier mobility.

From the calculation formula of the driving current I_{OLED}, when the carrier mobility μ increases, ΔVg increases, and (Vdata−ΔVg) decreases. When the carrier mobility μ decreases, ΔVg decreases, and (Vdata−ΔVg) increases. That is, by compensating for the carrier mobility 11, the influence of the change in the carrier mobility μ on the driving current I_{OLED} is reduced, thereby improving the problem of uneven display of the display panel.

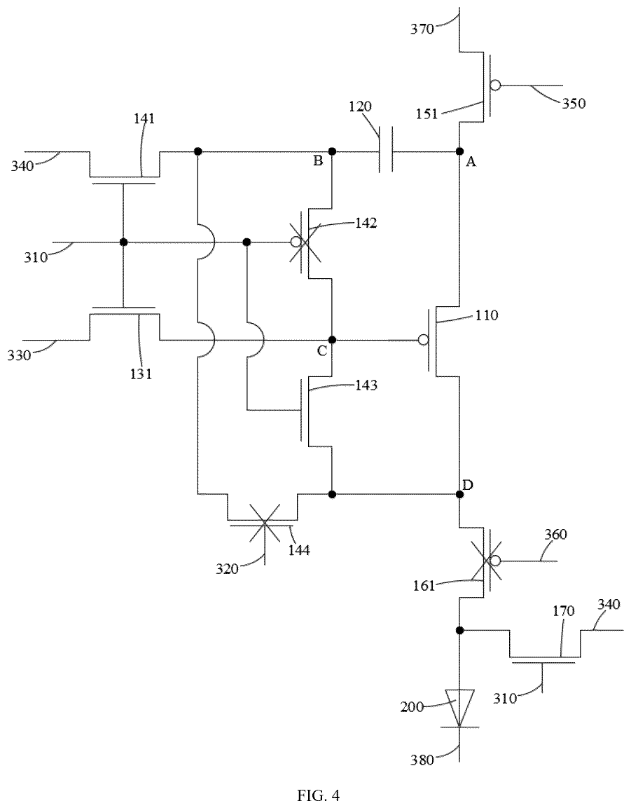

Specifically, FIG. 4 is a schematic diagram of the display driving circuit in the initialization stage in the second embodiment, and “X” in the figure indicates that the transistor is turned off. As shown in FIG. 4, in the initialization stage T1, the first scanning line 310 and the second light-emitting control line 360 are controlled to output high-level signals, and the second scanning line 320 and the first light-emitting control line 350 are controlled to output low-level signals. Then the third transistor 142, the fifth transistor 144, and the ninth transistor 161 are turned off, and the second transistor 141, the fourth transistor 143, the sixth transistor 170, the seventh transistor 131, and the eighth transistor 151 are turned on. At this time, the potential of the first node A is Vdd, the potential of the second node B is Vini, that is, OV, and the potentials of the third node C and the fourth node D are Vdata. The fifth transistor 144 is turned off, and Vini does not affect the fourth node D. Thus, the gate-source voltage difference of the first transistor 110 is Vgs=V_{C}−V_{A}=Vdata−VDD<Vth, so the first transistor 110 is turned on. For the display light-emitting unit 200, the ninth transistor 161 is turned off, and the VDD and Vdata signals do not affect the display light-emitting unit 200. Vini initializes the display light-emitting unit 200 through the sixth transistor 170.

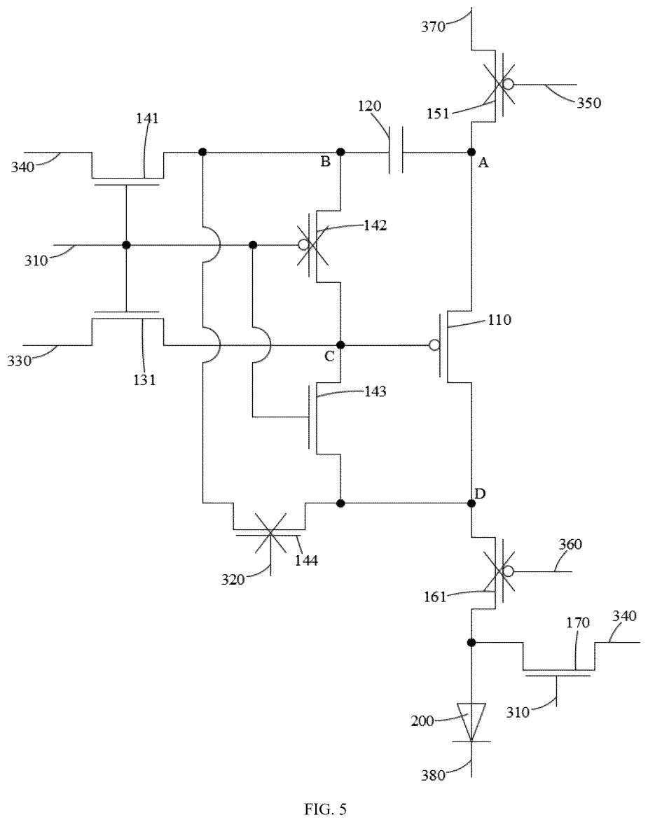

FIG. 5 is a schematic diagram of the display driving circuit in the data writing stage in the second embodiment, and “X” in the figure indicates that the transistor is turned off. As shown in FIG. 5, in the data writing stage T2, the first scanning line 310, the first light-emitting control line 350, and the second light-emitting control line 360 are controlled to output high-level signals, and the second scanning line 320 is controlled to output a low-level signal. Then the third transistor 142, the fifth transistor 144, the eighth transistor 151, and the ninth transistor 161 are turned off, and the second transistor 141, the fourth transistor 143, the sixth transistor 170, and the seventh transistor 131 are turned on. In this stage, the initial potential V_{A} of the first node A is Vdd. After the first transistor 110 is turned on, the data voltage Vdata charges the first node A through the fourth transistor 143 and the first transistor 110 until it is turned off when Vgs=Vth, that is, the potential V_{A} of the first node A becomes Vdata-Vth, that is, the data voltage Vdata and the threshold voltage Vth are written into the storage unit 120. The sixth transistor 170 is still in the on state, which prolongs the initialization time and further ensures that each display light-emitting unit 200 is in the same state before emitting light.

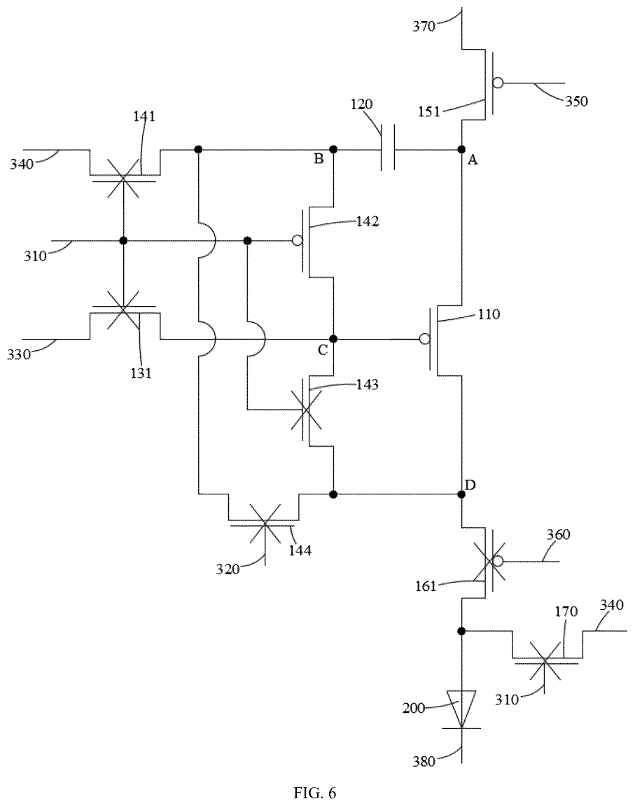

FIG. 6 is a schematic diagram of the display driving circuit in the first compensation stage in the second embodiment, and “X” in the figure indicates that the transistor is turned off. As shown in FIG. 6, in the first compensation stage T3, the second light-emitting control line 360 is controlled to output a high-level signal, and the first scanning line 310, the second scanning line 320, and the first light-emitting control line 350 are controlled to output low-level signals. Then the third transistor 142 and the eighth transistor 151 are turned on, and the second transistor 141, the fourth transistor 143, the fifth transistor 144, the sixth transistor 170, the seventh transistor 131, and the ninth transistor 161 are turned off. For the first transistor 110, at the beginning of this stage, the potential of the first node A is Vdata-Vth, and the first transistor 110 is turned off. Then, after the eighth transistor 151 is turned on, as Vdd charges the first node A, the potential of the first node A will become Vdd. And due to the conservation of charge, the change in the potential of the second node B is equal to the change in the potential of the first node A, so V_{B}=Vini+Vdd−(Vdata−Vth)=Vdd−Vdata+Vth. Since the third transistor 142 is turned on, V_{C}=V_{B}, so that the first transistor 110 is turned on again. Thus, the current I_{OLED} flowing through the first transistor 110 is:

$${I}_{OLED} = 1 / 2 \times μ \times k \times {( Vgs - Vth )}^{2}$$

Substituting V_{C}=V_{B}=Vdd−Vdata+Vth, the current I_{OLED} flowing through the first transistor 110 is:

$${I}_{OLED} = 1 / 2 \times μ \times k \times {Vdata}^{2}$$

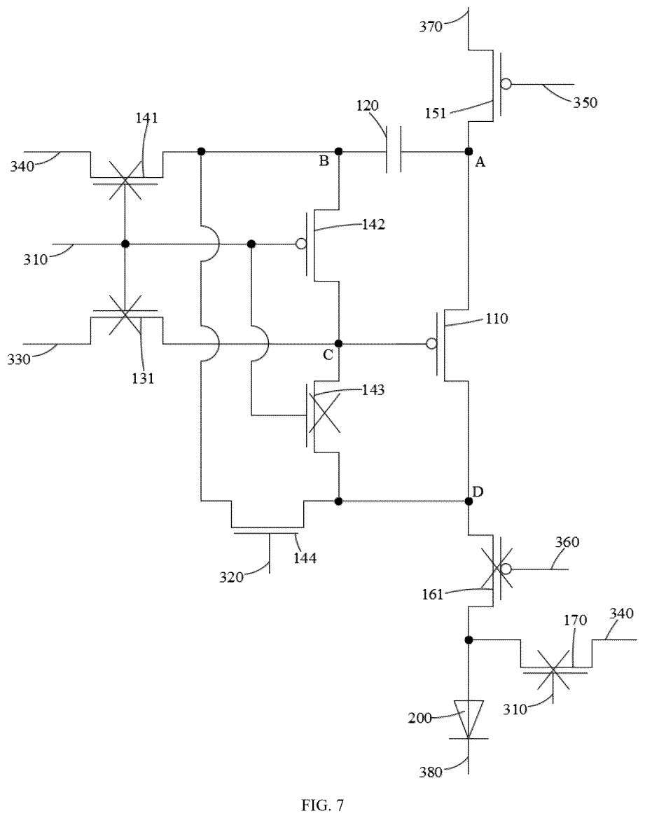

FIG. 7 is a schematic diagram of the display driving circuit in the second compensation stage in the second embodiment, and “X” in the figure indicates that the transistor is turned off. As shown in FIG. 7, in the second compensation stage T4, the second scanning line 320 and the second light-emitting control line 360 are controlled to output high-level signals, and the first scanning line 310 and the first light-emitting control line 350 are controlled to output low-level signals. Then the second transistor 141, the fourth transistor 143, the sixth transistor 170, the seventh transistor 131, and the ninth transistor 161 are turned off, and the third transistor 142, the fifth transistor 144, and the eighth transistor 151 are turned on. The first transistor 110 is in the on state, and the current flowing through the first transistor 110 will charge the second node B and the third node C through the fifth transistor 144. If the turn-on time of the fifth transistor 144 is controlled to be t, then the potential changes of the second node B and the third node C each is ΔVg=I×t/C, that is:

$${V}_{B} = {V}_{C} = Vdd - Vdata + Vth + Δ Vg$$

Then the driving current I_{OLED} flowing through the first transistor 110 becomes:

$${I}_{OLED} = 1 / 2 \times μ \times k \times {( Vdata - Δ Vg )}^{2}$$

where μ is the carrier mobility.

From the calculation formula of the driving current I_{OLED}, when the carrier mobility μ increases, ΔVg increases, and (Vdata−ΔVg) decreases. When the carrier mobility p decreases, ΔVg decreases, and (Vdata−ΔVg) increases. That is, by compensating for the carrier mobility μ, the influence of the change in the carrier mobility μ on the driving current I_{OLED} is reduced, thereby improving the problem of uneven display of the display panel.

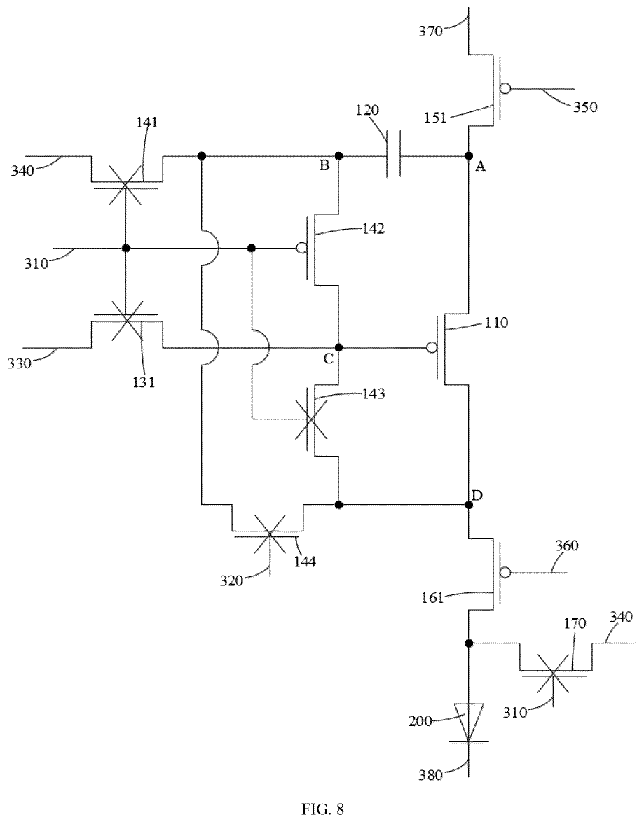

FIG. 8 is a schematic diagram of the display driving circuit in the light-emitting stage in the second embodiment, and “X” in the figure indicates that the transistor is turned off. As shown in FIG. 8, in the light-emitting stage T5, the first scanning line 310, the second scanning line 320, the first light-emitting control line 350, and the second light-emitting control line 360 are controlled to output low-level signals. Then the second transistor 141, the fourth transistor 143, the fifth transistor 144, the sixth transistor 170, and the seventh transistor 131 are turned off, and the third transistor 142, the eighth transistor 151, and the ninth transistor 161 are turned on. The first transistor 110 is turned on, and the current I_{OLED} flowing through the first transistor 110 is ½×μ×k×(Vdata−ΔVg)².

### The Third Embodiment

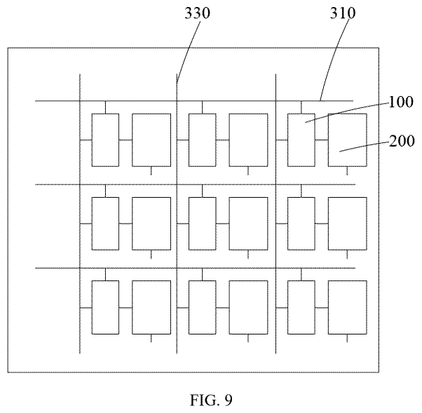

FIG. 9 is a schematic structural diagram of the display panel in the third embodiment. As shown in FIG. 9, the display panel in this embodiment includes a display driving circuit 100 and a display light-emitting unit 200. The display light-emitting unit 200 is connected to the second light-emitting control unit 160 of the display driving circuit 100, and the display driving circuit 100 includes the display driving circuit 100 disclosed in first embodiment.

The display panel includes a display driving circuit 100. In the display driving circuit 100, the two ends of the storage unit 120 are respectively connected to the first node A and the second node B. The first light-emitting control unit 150 is connected to the first light-emitting control line 350, the high-voltage end 370 of the power supply, and the first node A. The data writing unit 130 is connected to the first scanning line 310, the data line 330, and the third node C. The second light-emitting control unit 160 is connected to the second light-emitting control line 360, the fourth node D, and the anode of the display light-emitting unit 200. The cathode of the display light-emitting unit 200 is connected to the low-voltage end 380 of the power supply. The control end of the first transistor 110 is connected to the third node C, and the first and second ends of the first transistor 110 are respectively connected to the second node B and the fourth node D. The compensation unit 140 is connected to the second node B, the third node C, the fourth node D, the first scanning line 310, and the reference voltage line. The compensation unit 140 is configured to write the voltage of the reference voltage line, the power supply voltage Vdd, and the threshold voltage Vth of the first transistor 110 into the storage unit 120 in response to the scanning signal. By compensating for the threshold voltage Vth and the power supply voltage Vdd, the influence of the threshold voltage Vth and the power supply voltage Vdd on the driving current is eliminated, and the problem of uneven display on the display panel is improved.

The terms “first”, “second”, etc. are used for descriptive purposes only and cannot be understood as indicating or implying relative importance or implicitly indicating the number of the indicated technical features. Thus, a feature defined with “first”, “second”, etc. may explicitly or implicitly include one or more of such features. In the description of the present application, “multiple” means two or more, unless otherwise specifically defined.

In the present application, unless otherwise clearly specified and limited, the terms “assemble”, “connect”, etc. should be understood in a broad sense. For example, it can be a fixed connection, a detachable connection, or be integrated; it can be a mechanical connection or an electrical connection; it can be a direct connection or an indirect connection through an intermediate medium, and it can be the internal communication between two elements or the interaction relationship between two elements. For those skilled in the art, the specific meanings of the above terms in the present application can be understood according to specific situations.

In the description of this specification, descriptions referring to terms such as “some embodiments”, “exemplarily” mean that the specific features, structures, materials, or characteristics described in connection with the embodiment or example are included in at least one embodiment or example of the present application. In this specification, the schematic expressions of the above terms do not necessarily refer to the same embodiment or example. Moreover, the described specific features, structures, materials, or characteristics can be combined in a suitable manner in any one or more embodiments or examples. In addition, without contradiction, those skilled in the art can combine the different embodiments or examples and the features of different embodiments or examples described in this specification.

Although the embodiments of the present application have been shown and described above, it can be understood that the above-mentioned embodiments are exemplary and cannot be understood as limitations to the present application. Those skilled in the art can make changes, modifications, substitutions, and variations to the above-mentioned embodiments within the scope of the present application. Therefore, any changes or modifications made according to the claims and the specification of the present application shall fall within the scope covered by the patent of the present application.

1. A display driving circuit, comprising: a first transistor connected to a display light-emitting unit;
wherein the display driving circuit further comprises:
a storage unit, with a first end connected to a first end of the first transistor through a first node;
a first light-emitting control unit, connected to a first light-emitting control line, a high-voltage end of a power supply, and the first node;
a compensation unit, connected to a second end of the storage unit through a second node, connected to a control end of the first transistor through a third node, and connected to a second end of the first transistor through a fourth node, wherein the compensation unit is also connected to a first scanning line and a reference voltage line, and is configured to write a voltage of the reference voltage line, a voltage of a high-voltage end of the power supply, and a threshold voltage of the first transistor into the storage unit in response to a signal of the first scanning line;
a data writing unit, connected to the first scanning line, a data line, and the third node, wherein the data writing unit is configured to write a signal of the data line into the storage unit in response to the signal of the first scanning line; and
a second light-emitting control unit, connected to a second light-emitting control line, the fourth node, and an anode of the display light-emitting unit;
wherein a cathode of the display light-emitting unit is connected to a low-voltage end of the power supply.

2. The display driving circuit according to claim 1, wherein the compensation unit comprises a second transistor, a third transistor, and a fourth transistor;
the first transistor and the third transistor are P-type transistors, and the second transistor and the fourth transistor are N-type transistors;
a control end of the second transistor is connected to the first scanning line, a first end of the second transistor is connected to the reference voltage line, and a second end of the second transistor is connected to the second node;
a control end of the third transistor is connected to the first scanning line, a first end of the third transistor is connected to the second node, and a second end of the third transistor is connected to the third node; and
a control end of the fourth transistor is connected to the first scanning line, a first end of the fourth transistor is connected to the third node, and a second end of the fourth transistor is connected to the fourth node.

3. The display driving circuit according to claim 2, wherein the voltage of the reference voltage line is 0.

4. The display driving circuit according to claim 2, wherein the compensation unit further comprises a fifth transistor, which is an N-type transistor;
a control end of the fifth transistor is connected to a second scanning line, a first end of the fifth transistor is connected to the second node, and a second end of the fifth transistor is connected to the fourth node.

5. The display driving circuit according to claim 2, further comprising a sixth transistor, which is an N-type transistor;
wherein a control end of the sixth transistor is connected to the first scanning line, a first end of the sixth transistor is connected to an initialization signal line, and a second end of the sixth transistor is connected to the anode of the display light-emitting unit.

6. The display driving circuit according to claim 5, wherein a voltage of the initialization signal line is 0, and the reference voltage line is the initialization signal line.

7. The display driving circuit according to claim 5, wherein the voltage of the initialization signal line is greater than a power supply voltage of the low-voltage end of the power supply, and a voltage difference between the voltage of the initialization signal line and the power supply voltage of the low-voltage end of the power supply is less than a starting voltage of the display light-emitting unit for emitting light.

8. The display driving circuit according to claim 2, wherein the data writing unit comprises a seventh transistor, which is an N-type transistor; and
a control end of the seventh transistor is connected to the first scanning line, a first end of the seventh transistor is connected to the data line, and a second end of the seventh transistor is connected to the third node.

9. The display driving circuit according to claim 2, wherein the first light-emitting control unit comprises an eighth transistor, which is a P-type transistor; and
a control end of the eighth transistor is connected to the first light-emitting control line, a first end of the eighth transistor is connected to the high-voltage end of the power supply, and a second end of the eighth transistor is connected to the first node.

10. The display driving circuit according to claim 2, wherein the second light-emitting control unit comprises a ninth transistor, which is a P-type transistor; and
a control end of the ninth transistor is connected to the second light-emitting control line, a first end of the ninth transistor is connected to the fourth node, and a second end of the ninth transistor is connected to the anode of the display light-emitting unit.

11. A display driving method for driving a display driving circuit,
wherein the display driving circuit comprises:
a first transistor, connected to a display light-emitting unit;
a storage unit, with a first end connected to a first end of the first transistor through a first node;
a first light-emitting control unit, connected to a first light-emitting control line, a high-voltage end of a power supply, and the first node;
a compensation unit, connected to a second end of the storage unit through a second node, connected to a control end of the first transistor through a third node, and connected to a second end of the first transistor through a fourth node, wherein the compensation unit is also connected to a first scanning line and a reference voltage line, and is configured to write a voltage of the reference voltage line, a voltage of a high-voltage end of the power supply, and a threshold voltage of the first transistor into the storage unit in response to a signal of the first scanning line;
a data writing unit, connected to the first scanning line, a data line, and the third node, wherein the data writing unit is configured to write a signal of the data line into the storage unit in response to the signal of the first scanning line; and
a second light-emitting control unit, connected to a second light-emitting control line, the fourth node, and an anode of the display light-emitting unit;
wherein a cathode of the display light-emitting unit is connected to a low-voltage end of the power supply;
wherein the display driving method comprises:
in an initialization phase, controlling the first scanning line and the second light-emitting control line to output high-level signals, and controlling the first light-emitting control line to output a low-level signal, to turn on the first light-emitting control unit and the data writing unit, and turn off the second light-emitting control unit, and writing the voltage of the high-voltage end of the power supply into the first node and write a data voltage of the data line into the third node to turn on the first transistor;
in a data writing phase, controlling the first scanning line, the first light-emitting control line, and the second light-emitting control line to output high-level signals, to turn on the data writing unit and turn off the first light-emitting control unit and the second light-emitting control unit, to write the data voltage and the threshold voltage of the first transistor into the first node;
in a first compensation phase, controlling the second light-emitting control line to output a high-level signal, and controlling the first scanning line and the first light-emitting control line to output low-level signals, to turn on the first light-emitting control unit and turn off the data writing unit and the second light-emitting control unit, to write the voltage of the reference voltage line, the data voltage, the threshold voltage, and the voltage of the high-voltage end of the power supply into the second node and the third node; and
in a light-emitting phase, controlling the first scanning line, the first light-emitting control line, and the second light-emitting control line to output low-level signals, to turn on the first light-emitting control unit, the first transistor, and the second light-emitting control unit to drive the display light-emitting unit to emit light.

12. The display driving method according to claim 11, further comprising:
in a second compensation phase, controlling a second scanning line and the second light-emitting control line to output high-level signals, and controlling the first scanning line and the first light-emitting control line to output low-level signals, to turn on the first light-emitting control unit, a third transistor, a fifth transistor, and a first transistor, and turn off a second transistor and a fourth transistor; and controlling potential changes of a second node and a third node by controlling a turn-on time of the fifth transistor to compensate for a carrier mobility μ.

13. The display driving method according to claim 11, wherein in the initialization phase, a third transistor, a fifth transistor, and a ninth transistor are turned off, a second transistor, a fourth transistor, a sixth transistor, a seventh transistor, and an eighth transistor are turned on, and the first transistor is turned on.

14. The display driving method according to claim 11, wherein in the data writing phase, a third transistor, a fifth transistor, an eighth transistor, and a ninth transistor are turned off, a second transistor, a fourth transistor, a sixth transistor, and a seventh transistor are turned on, and the first transistor is turned on.

15. The display driving method according to claim 11, wherein in the first compensation phase, a third transistor and an eighth transistor are turned on, a second transistor, a fourth transistor, a fifth transistor, a sixth transistor, a seventh transistor, and a ninth transistor are turned off, and the first transistor is turned off and then turned on again.

16. The display driving method according to claim 11, wherein in the light-emitting phase, a second transistor, a fourth transistor, a fifth transistor, a sixth transistor, and a seventh transistor are turned off, a third transistor, an eighth transistor, and a ninth transistor are turned on, and the first transistor is turned on.

17. A display panel, comprising:
a display driving circuit, wherein the display driving circuit comprises:
a first transistor, connected to a display light-emitting unit;
a storage unit, with a first end connected to a first end of the first transistor through a first node;
a first light-emitting control unit, connected to a first light-emitting control line, a high-voltage end of a power supply, and the first node;
a compensation unit, connected to a second end of the storage unit through a second node, connected to a control end of the first transistor through a third node, and connected to a second end of the first transistor through a fourth node, wherein the compensation unit is also connected to a first scanning line and a reference voltage line, and is configured to write a voltage of the reference voltage line, a voltage of a high-voltage end of the power supply, and a threshold voltage of the first transistor into the storage unit in response to a signal of the first scanning line;
a data writing unit, connected to the first scanning line, a data line, and the third node, wherein the data writing unit is configured to write a signal of the data line into the storage unit in response to the signal of the first scanning line;
a second light-emitting control unit, connected to a second light-emitting control line, the fourth node, and an anode of the display light-emitting unit; and
a display light-emitting unit, connected to the second light-emitting control unit of the display driving circuit, wherein a cathode of the display light-emitting unit is connected to a low-voltage end of the power supply.

18. The display panel according to claim 17, wherein the compensation unit comprises a second transistor, a third transistor, and a fourth transistor;
the first transistor and the third transistor are P-type transistors, and the second transistor and the fourth transistor are N-type transistors;
a control end of the second transistor is connected to the first scanning line, a first end of the second transistor is connected to the reference voltage line, and a second end of the second transistor is connected to the second node;
a control end of the third transistor is connected to the first scanning line, a first end of the third transistor is connected to the second node, and a second end of the third transistor is connected to the third node; and
a control end of the fourth transistor is connected to the first scanning line, a first end of the fourth transistor is connected to the third node, and a second end of the fourth transistor is connected to the fourth node.

19. The display panel according to claim 18, wherein the voltage of the reference voltage line is 0.

20. The display panel according to claim 18, wherein the compensation unit further comprises a fifth transistor, which is an N-type transistor;
a control end of the fifth transistor is connected to a second scanning line, a first end of the fifth transistor is connected to the second node, and a second end of the fifth transistor is connected to the fourth node.
